(19) United States
(12) Patent Application Publication
(10) Pub. No.: US 2020/0347862 A1
(43) Pub. Date: Nov. 5, 2020

(54) IMPROVEMENTS IN FASTENERS

(71) Applicant: TITUS D.O.O. DEKANI, Dekani (SI)

(72) Inventors: Andrej Slak, Koper (SI); Robert Lukezic, Portoroz (SI)

(21) Appl. No.: 16/958,273

(22) PCT Filed: Jan. 2, 2019
(86) PCT No.: PCT/EP2019/050037

§ 371 Date: Jun. 26, 2020

(30) Foreign Application Priority Data
Jan. 4, 2018 (GB) 1800136.2

(51) Int. Cl. F16B 5/01; F16B 13/06

(52) U.S. Cl. CPC F16B 5/01; F16B 13/066

(57) ABSTRACT

A fastener for a hollow core panel is provided, where the panel is of the kind including two spaced apart skins. The fastener has an elongate element that is insertable into the panel via a first one of its skins. The fastener includes a screw-threaded formation to enable attachment of its elongate element to the first skin. This secures the fastener to the panel. The elongate element is arranged to have sufficient length to extend far enough into the panel to engage with its second skin.

### TECHNICAL FIELD

This invention relates to fasteners for use in particular, though not exclusively, on hollow core panels.

### BACKGROUND

Hollow core panels, also known as honeycomb boards, are often used in the building and furniture industries nowadays as an inexpensive lightweight substitute for solid interior doors, partitions and furniture elements. They have a characteristic structure typically consisting of two external layers or “skins” of material such as plywood or MDF, separated by and bonded to a lattice-like internal array of material such as cardboard. These panels have very little inherent strength compared with traditional solid panels, which makes it difficult to form joints between them and/or secure fittings to them such as hinges and handles.

### SUMMARY

The invention provides a fastener for a hollow core panel of the kind comprising two spaced apart skins, the fastener having an elongate element insertable in use into the panel via a first one of its skins and having means for attaching the elongate element to said first skin whereby to secure the fastener to the panel, with the elongate element being arranged to extend sufficiently far into the panel to additionally engage with its second skin.

By way of example, embodiments of the invention will now be described with reference to the accompanying drawings, in which:

### BRIEF DESCRIPTION OF DRAWINGS

FIGS. 1a to 1d show in sectional view various forms of fastener according to the invention,

FIG. 2 shows in sectional view the fastener of FIG. 1a in use in a joint between two hollow core panels,

FIG. 3 shows in sectional view a further form of fastener according to the invention in various stages of assembly, and

FIG. 4 shows a component part of the fastener of FIG. 3.

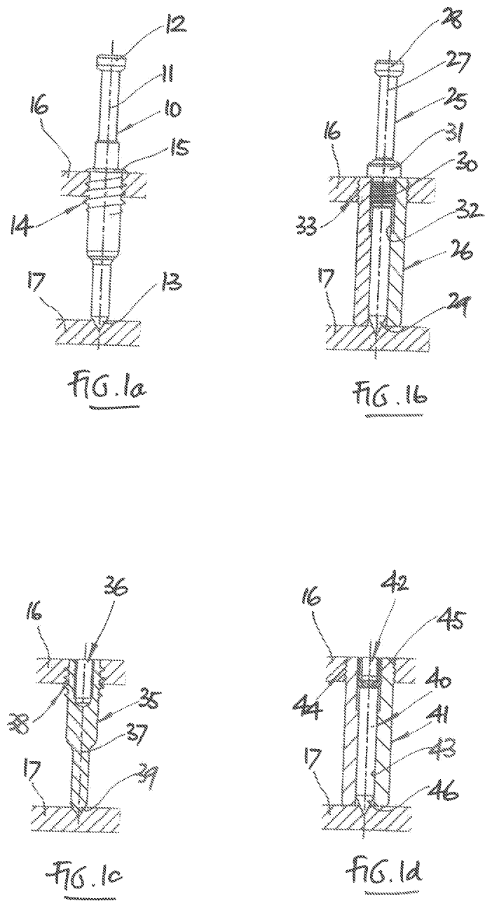

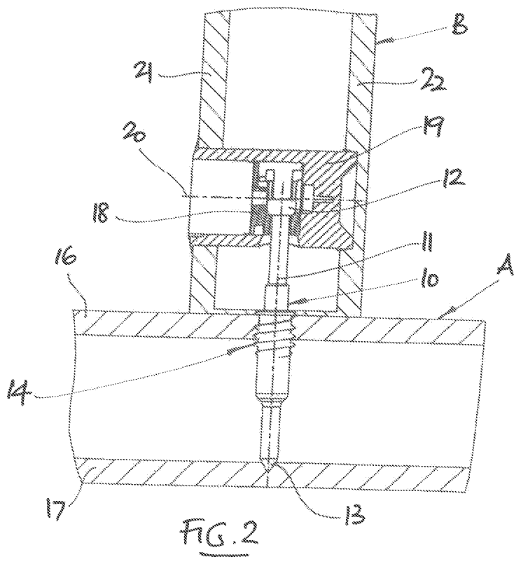

The fastener seen in FIG. 1a is in the form of an elongate dowel 10 having a longitudinal axis 11. The dowel 10 is of a suitable material such as cast zinc or rolled steel. It has a head 12 at one end. At its other end, the dowel 10 terminates in a point 13. In its middle region, the dowel 10 is formed with a screw-threaded section 14 and a flange 15.

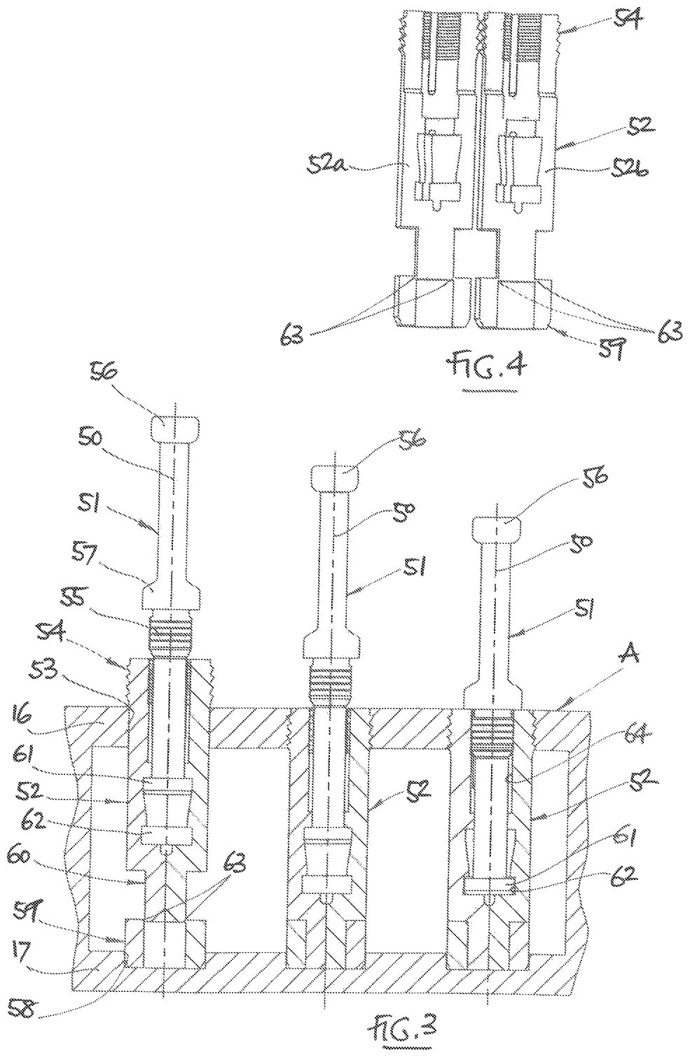

As seen particularly in FIG. 2, the dowel 10 is designed to be anchorable in a hollow core panel A, with its axis 11 extending at a right angle to the plane of the panel. The dowel 10 is screwed into the panel A, typically via a pre-drilled pilot hole in its skin 16, with the screw-threaded section 14 being arranged to cut into engagement with the skin in the manner of a self-tapping screw. The dowel 10 is screwed into the panel A until the flange 15 tightens down onto the skin 16, thus producing a secure fixing.

It will be understood that the flange 15 will act as a limit stop, ensuring that the head 12 of the dowel 10 is spaced as desired from the panel surface. The need for this is explained in more detail below. It also ensures that the point 13 of the dowel 10 engages the opposite skin 17 of the panel A as desired, which is by partially penetrating into it. The engagement of the point 13 with the skin 17 in this manner is intended to provide lateral support for the inner end of the dowel 10. The purpose of this is to help prevent the dowel 10 being tilted out of square with the panel A, as might occur from forces acting transversely on the head 12. That the point 13 penetrates only partially into the skin 17 means that the external appearance of the panel A is not affected. The fact that the end of the dowel 10 is pointed avoids the need for any pre-preparation of the skin 17.

As seen in FIG. 2, the head 12 of the dowel 10 is designed to be engaged by a tightening element mounted in another panel B to which panel A is to be connected. The tightening element here is in the form of a conventionally known rotatable cam 18. The cam 18 is mounted within a housing 19 for rotation about an axis 20 that is perpendicular to the axis 11 of the dowel 10. The housing 19 is secured to the panel B between its outer skins 21, 22. The cam 12 can be rotated by a hand tool such as a screwdriver or the like. In known manner, rotation of the cam 12 serves to exert an axial force on the head 12 of the dowel 10 which thereby pulls the two panels A and B together.

It will be appreciated that the head 12 of the dowel 10 needs to be spaced correctly from the surface of panel A in order to engage properly with the cam 18 in panel B. The flange 15 on the dowel 10 ensures that this is so.

An alternative form of fastener is seen in FIG. 1b. Here, the fastener consists of a dowel 25, typically of metal, and a sleeve 26, typically of plastics material. The dowel 25 is of elongate form, with a longitudinal axis 27. It has a head 28 at one end for engaging a tightening element such as the rotatable cam 18 in FIG. 2. At the other end, the dowel 10 has point 29 for engaging the skin 17 of a panel such as is seen in FIG. 2. In its middle region, the dowel 25 has an expander section 30 and a collar 31.

The sleeve 26 has a bore 32 that slidably receives the dowel 25. At one end, the sleeve 26 has a split section 33 that allows it to be outwardly expandable. The sleeve 26 is designed to be inserted into the panel A via a mounting hole in the skin 16. With the sleeve 26 thus in place, the dowel 10 is then pushed into the bore 32 of the sleeve so that its expander section 30 causes outward expansion of the split section 33. This brings the sleeve 26 into a conventionally known kind of force-fit engagement with the mounting hole in the skin 16. The split section 33 of the sleeve 26 has a serrated outer profile to enhance the security of this fixing in the skin 16.

The expander section 30 of the dowel 26 has circumferentially extending serrations, as does the area of the bore 32 of the sleeve 26 with which it engages. The purpose of this arrangement is to provide resistance to retraction of the dowel 26 out of the sleeve 26 once it has been engaged with it in the panel A. The serrations may have a barbed profile to enhance this effect.

With the dowel 25 and sleeve 26 set in the panel A, the collar 31 sits tight against the skin 16. This ensures that the head 28 of the dowel 25 is spaced as desired from the panel A, for reasons as explained above. It also ensures that the point 29 of the dowel 25 engages as desired with the opposite skin 17 of the panel A, ie in partial penetration, again for reasons as explained above.

The fastener seen in FIG. 1c is of a slightly different kind. Here, the fastener is in the form of an insert 35 that is intended to provide a means of anchorage for a fixing element such a machine screw. The insert 35 has a tapped hole 36 for this purpose. This can be used to attach fittings such as hinges or handles to the panel.

The insert 35 is of elongate form, with a longitudinal axis 37. At one end, it has a screw-threaded section 38. As with the fastener seen in FIG. 1a, the insert 35 is intended to be screwed into the skin 16 of the panel, typically via a pilot hole, with the screw-threaded section 38 cutting into engagement with the skin in the manner of a self-tapping screw.

At its other end, the insert 35 terminates in a point 39. The point 39 is intended to engage the opposite skin 17 when the insert 35 is screwed fully into the panel. In particular, the point 39 is designed to penetrate only partially into the skin 17 when the insert 35 is screwed in flush with the surface of the panel. For the same reasons as explained above, this provides lateral support for the inner end of the insert 35, without affecting the external appearance of the panel.

The fastener seen in FIG. 1d is akin to the fastener of FIG. 1c in that it is in the form of an insert that is intended to provide a means of anchorage for a fixing element such a machine screw. In this case, however, the insert is of composite form, with a pin 40 and sleeve 41. The fastener again presents a tapped hole 42 for attachment of fittings such as hinges or handles to a panel.

The sleeve 41 has a bore 43 that slidably receives the pin 40. At one end, the sleeve 41 has a split section 44 that allows it to be outwardly expandable. At one end, the pin 40 has an expander section 45. The sleeve 41 is designed to be inserted into the panel via a mounting hole in the skin 16. With the sleeve 41 thus in place, the pin 40 is pushed into the bore 43 of the sleeve so that its expander section 45 causes outward expansion of the split section 44. This brings the sleeve 41 into a conventionally known kind of force-fit engagement with the mounting hole in the skin 16. The split section 44 of the sleeve 41 has a serrated outer profile to enhance the security of this fixing in the skin.

At its other end, the pin 40 terminates in a point 46. The point 46 is intended to engage the opposite skin 17 of the panel when the pin 40 is pressed fully into it. In particular, the point 46 is designed to penetrate only partially into the skin 17 when the pin 40 and sleeve 41 lie flush with the surface of the panel. For the same reasons as explained above, this provides lateral support for the inner end of the insert 35, without affecting the external appearance of the panel.

Another form of fastener is seen in FIG. 3. This is of similar design to the fastener of FIG. 1b. It is again of elongate form, with a longitudinal axis 50, and consists of a dowel 51, typically of metal, and a sleeve 52, typically of plastics material. The dowel 51 has a head 56 and a flange 57. When in position, the head 56 is designed to engage a tightening element such as the cam 18 seen in FIG. 2. The flange 57 acts as a limit stop to ensure the correct spacing of the head 56 from the panel for this purpose.

As seen in FIG. 4, the sleeve 52 is conveniently formed of two half shells 52a, 52b that connect together around the dowel 51. The sleeve 52 has a slotted expandable section 54 at one end. This is designed to be operatively engaged by an expander section 55 of the dowel 51 to create a force-fit engagement with a skin 16 of a panel A, as described above. The dowel 51 and sleeve 52 are preferably provided with circumferentially extending serrations at this point of engagement with the skin 16 to enhance the resistance of the dowel to being pulled out of the panel A.

One difference with this fastener is in the manner of its engagement with the opposite skin 17 of the panel A. Here, the inner end of the sleeve 52 is designed to engage in a blind hole 58 pre-drilled into the skin 17. The sleeve 52 is designed here to have an annular end section 59 that is connected to a reduced-diameter portion 60 of the sleeve 52 by a frangible web of material 63. An axial force applied to the sleeve 52 is designed to cause the web 63 to break, allowing the reduced-diameter portion 60 of the sleeve 52 to enter into the bore of the annular end section 59. The annular end section 59 is designed to fit snugly within the blind hole 58 in the skin 17. As before, this engagement provides lateral location for the inner end of the fastener, hence helping it to resist tilting of its axis 50 out of square with the panel A.

Another difference is that the dowel 51 here terminates at its inner end in a flange 61. This is designed to be captured within an enlarged counterbore 62 in the bore 64 of the sleeve 52 when the fastener is in its fixed position in the panel A (as seen in the right-hand illustration of FIG. 3). The elasticity of the material of which the sleeve 52 is made enables it to flex and allow this engagement to take place. Once in position, the flange 61 and counterbore 62 together produce a form-fitting block to prevent the dowel 51 from being retracted out of the sleeve 52. This provides additional security for preventing the dowel 51 from being pulled out of the panel A.

While the disclosed technology has been described with respect to a limited number of embodiments, those skilled in the art, having benefit of this disclosed technology, will appreciate that other embodiments can be devised which do not depart from the scope of the disclosed technology as disclosed herein. Accordingly, the scope of the disclosed technology should be limited only by the attached claims.

1. A fastener for a hollow core panel of the kind comprising:
two spaced apart skins, the fastener having an elongate element insertable in use into the panel via a first one of its skins and having means for attaching the elongate element to said first skin whereby to secure the fastener to the panel, with the elongate element being arranged to extend sufficiently far into the panel to additionally engage with its second skin.

2. A fastener as claimed in claim 1 wherein said engagement of the elongate element with the second skin of the panel is by partial penetration into said second skin.

3. A fastener as claimed in claim 2 wherein the elongate element is arranged to engage directly with said second skin.

4. A fastener as claimed in claim 2 wherein the elongate element is shaped to achieve said partial penetration without pre-preparation of said second skin.

5. A fastener as claimed in claim 2 wherein the elongate element is arranged to engage with said second skin indirectly and said partial penetration requires pre-preparation of the second skin.

6. A fastener as claimed in claim 5 wherein the elongate element is arranged to engage the second skin via a sleeve, with said second skin being pre-drilled with a blind hole for receiving said sleeve.

7. A fastener as claimed in claim 1 wherein the means for attaching the elongate element to said first skin is in the form of a screw-threaded connection.

8. A fastener as claimed in claim 1 wherein means for attaching the elongate element to said first skin is in the form of a force-fit connection.

9. A fastener as claimed in claim 1 wherein the elongate element comprises a limit stop to determine the extent of its insertion into the panel.

10. A fastener as claimed in claim 1 wherein the elongate element is designed to have a part thereof extending out of the panel at a right angle thereto when the fastener is secured to the panel.

11. A fastener as claimed in claim 10 wherein said part of the elongate element extending out of the panel terminates in a head, with the limit stop acting to determine the spacing of the head from the panel.

12. A fastener as claimed in claim 8 wherein the fastener additionally comprises a sleeve, with the sleeve and elongate element co-operating to provide said force-fit connection.

13. A fastener as claimed in claim 12 wherein the sleeve comprises an outwardly expandable portion and the elongate element comprises an expander section engageable therewith to cause said force-fit connection.

14. A fastener as claimed in claim 13 wherein the elongate element and/or the sleeve are provided with irregularities on their respective contact surfaces to resist relative axial movement therebetween.

15. A fastener as claimed in claim 14 wherein said surface irregularities comprise a barbed profile whereby resistance is provided in only one axial direction.

16. A fastener as claimed in claim 8 wherein the elongate element comprises a flange which co-operates with the sleeve to prevent retraction of the elongate element from the sleeve once the fastener has been secured to the panel.

17. A fastener as claimed in claim 1 wherein the elongate element is in the form of an insert presenting a screw-threaded connector for attachment of a fitting to the panel.

18. A fastener as claimed in claim 3 wherein the elongate element is shaped to achieve said partial penetration without pre-preparation of said second skin.
